(19) United States
(12) Patent Application Publication
(10) Pub. No.: US 2019/0010811 A1
(43) Pub. Date: Jan. 10, 2019

(54) METHOD FOR MANUFACTURE OF HIGH TEMPERATURE CYLINDRICAL COMPONENT FOR A GAS TURBINE ENGINE

(71) Applicant: ROLLS-ROYCE plc, London (GB)

(72) Inventors: Oliver JONES, Nottingham (GB); Luke FREEMAN, Derby (GB)

(73) Assignee: ROLLS-ROYCE plc, London (GB)

(21) Appl. No.: 15/406,418

(22) Filed: Jan. 13, 2017

(30) Foreign Application Priority Data
Jan. 28, 2016 (GB) 1601564.6

(51) Int. Cl. F01D 5/28; F01D 11/08; C22C 38/50; C23C 4/129

(52) U.S. Cl. CPC F01D 5/286; F01D 5/288; F01D 11/08; F05D 2300/701; C23C 4/129; F05D 2230/90; C22C 38/50

(57) ABSTRACT

A method for the manufacture of a cylindrical component suited to use in a high temperature environment and incorporating an erosion resistant coating (4) on its outer cylindrical surface (6) is described. The method comprises, in sequential steps; providing a work piece (1) having a cylindrical body including a pair of axially spaced radially extending ribs (3a, 3b) defining an annular trough (2) therebetween. Shot peening the work piece (1). Applying an erosion resistant coating (4) in the annular trough (2) to a depth which sits radially inwardly of the radially outermost ends of the ribs (3a, 3b). Turning the radially outermost ends of the ribs (3a, 3b) whereby to match the depth of the coating (4) and provide an outer cylindrical surface with a consistent diameter across both ribs (3a, 3b) and the coating (4).

### FIELD OF THE INVENTION

The present invention relates to cylindrical components suited to use in high temperature environments, for example (but not exclusively) a compressor drum for a gas turbine engine. More particularly the invention relates to methods of manufacture of such components having radially outer surfaces which, in use, are susceptible to erosion due to relative rotation with respect to an adjacent component and thermal expansion and retraction changing the separation distance between the components and which are provided with an erosion resistant coating to minimise damage caused by such wear.

### BACKGROUND TO THE INVENTION

FIG. 1 shows in cross section, one half of a compressor drum for use in a gas turbine engine. When in situ in an engine, the outer circumference of the drum faces suspended ends of one or more arrays of stator vanes. The radial gap between the components is designed to be large enough to allow the drum to rotate relative to the stator but be maintained as small as possible so as to prevent leakage of compressor gases downstream. Due to the high temperatures and loads achieved within the engine, thermal expansion can result in the gap narrowing to an extent that the outer circumferential surface of the drum contacts the stator vanes. Such contact may also arise following a compressor surge. This can result in erosion which can impact on the interval between repairs and potentially the useful life of the drum. To address this problem, an erosion resistant coating is applied to the outer circumferential surface of the drum.

As can be seen in FIG. 1, the outer circumferential surface of the drum 1 is provided with a circumferentially extending trough 2 defined by axially separated, radially extending ribs. An erosion resistant coating is deposited in the trough. The diameter of the drum is finished to be consistent across the ribs 3a, 3b and the coating 4 in between.

FIG. 2 demonstrates the steps of a known method for manufacturing the drum illustrated in FIG. 1. The steps are performed in the sequence a), b), c), d) as shown in the Figure. In step a) the drum 1 is formed from two disc forgings welded at weld 5. The welded drum has a circumferentially outer surface 6 and circumferentially inner surface 7. Ribs 3a and 3b which may be machined from the welded forgings define the trough 2. In step b), the coating 4 is applied, typically using a thermal spraying method, such as plasma spraying. The coating 4 is built up to be a depth d higher than the trough 2 and so sits proud of the trough 2. In step c) the outer circumferential surface of the drum 1 including the applied coating 4 is ground to provide a uniform outside diameter across both ribs 3a, 3b and the coating 4. The grinding process leaves the ground alloy in a state of tensile stress which can leave the drum vulnerable to propagation of micro-cracks. To counter this vulnerability, in step d) the machined drum is subjected to shot peening which imposes a state of compressive stress at the surfaces countering the tensile stresses and reducing the likelihood of any crack propagation at the surface in the finished product. The coating may be shielded during this process.

This known method has worked well for prior known coatings and drum materials, however with the advancement in gas turbine engine technology, operating temperatures and loads have increased and new materials are being adopted. Not all of these new materials are suited to the prior art method.

There is desire for an alternative method for the manufacture of cylindrical components suited to use in high temperature environments which components include a wear resistant coating.

### STATEMENT OF THE INVENTION

The present invention provides a method for the manufacture of a cylindrical component suited to use in a high temperature environment and incorporating an erosion resistant coating on its outer cylindrical surface, the method comprising; providing a work piece having a cylindrical body including a pair of axially spaced radially extending ribs defining an annular trough therebetween, shot peening the work piece, applying an erosion resistant coating in the annular trough to a depth which sits radially inwardly of the radially outermost ends of the ribs,

turning the radially outermost ends of the ribs whereby to match the depth of the coating and provide an outer cylindrical surface with a consistent diameter across both ribs and the coating.

For example, the cylindrical component may be configured to serve as a drum of a compressor of a gas turbine engine. The work piece may comprise a drum made from a plurality of disc forgings welded together. The trough may extend across one or more welded joints. A compressor drum made in accordance with the invention may further comprise one or more arrays of rotor blades positioned axially at opposite ends of the rough and which may be integral with or mechanically fixed to the drum.

The erosion resistant coating may be applied using a thermal spraying process. For example, the thermal spraying process is plasma spraying. Alternative thermal spraying processes include, without limitation, detonation spraying, wire arc spraying, flame spraying and high velocity oxy-fuel coating spraying (HVOF).

The work piece may comprise a high temperature alloy. Optionally the high temperature alloy is a nickel based alloy or a titanium based alloy. The method of the invention is not restricted in application to any specific alloy.

The coating may comprise a single layer or multi-layered coating. The coating includes an erosion resistant layer. Preferably the coating is a self-bonding coating. The erosion resistant layer may comprise a particulate mass which is applied to the work piece by means of a thermal spraying process. The particles may provide a density in the coating of between about 3 and about 5 g/cm³. For example, the particles of the coating comprise a mechanically clad, chemically clad or gas atomised combination of Nickel and Aluminium. The erosion resistant layer may comprise greater than 80% Nickel for example about 90-96% Nickel.

Optionally, the coating may also include a top coat comprising a layer of thermally insulating material. The top coat may comprise substantially of a ceramic material. For example, the top coat comprises an Yttria stabilised Zirconia (YSZ). For example, the YSZ may comprise upwards of about 90% Zircona, more particularly 91-93% Zirconia and upto about 9% Yttria. The top coat may be provided from a powder using a thermal spraying process.

The work piece may be provided from a plurality of disc forgings welded in axial alignment. The trough may be provided by a turning operation removing material from the outside circumference to form the ribs and the trough therebetween. As an intermediate process, the trough might be processed to prepare for the coating. For example the trough is grit blasted to provide a good keying surface for bonding of the coating.

### BRIEF DESCRIPTION OF DRAWINGS

An embodiment of the method of the invention is now described with reference to the accompanying drawings in which;

FIG. 1 shows in cross section, one half of a compressor drum for use in a gas turbine engine as is known from the prior art;

FIG. 2 shows sequential steps of a prior known method for the manufacture of the compressor drum of FIG. 1;

FIG. 3 shows sequential steps of a method of manufacture according to an embodiment of the invention;

FIG. 4 shows a section of a gas turbine engine into which cylindrical components made in accordance with the invention might be incorporated.

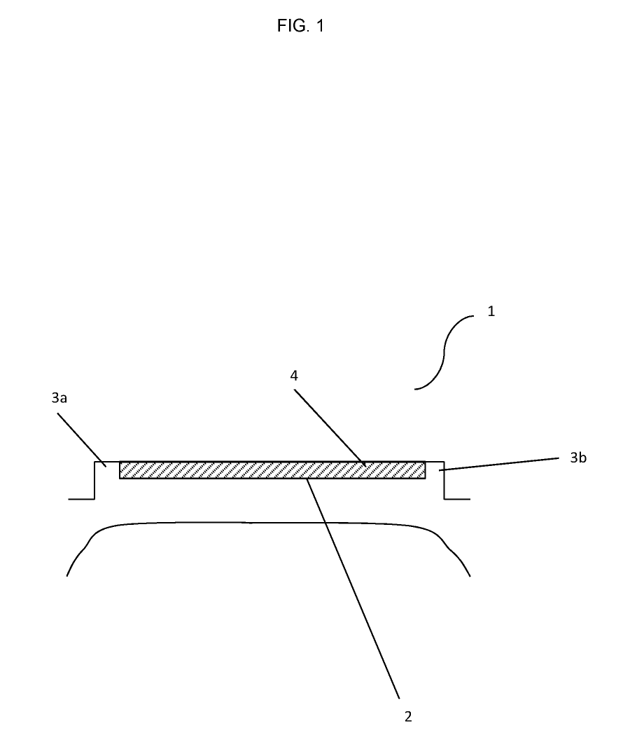

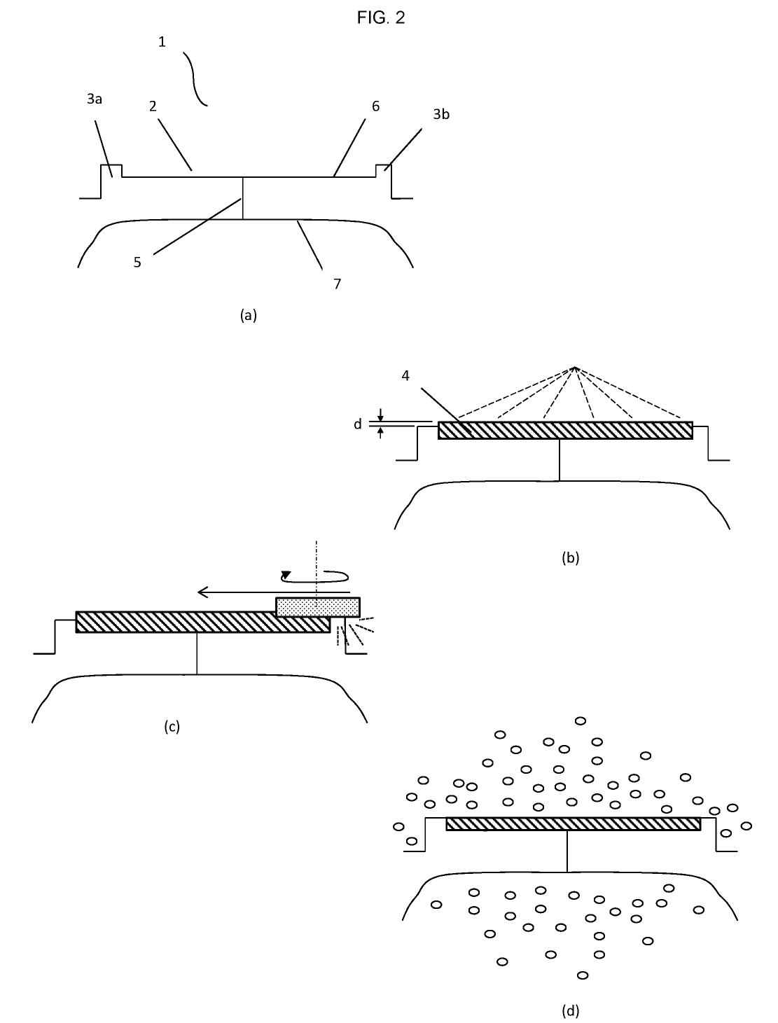

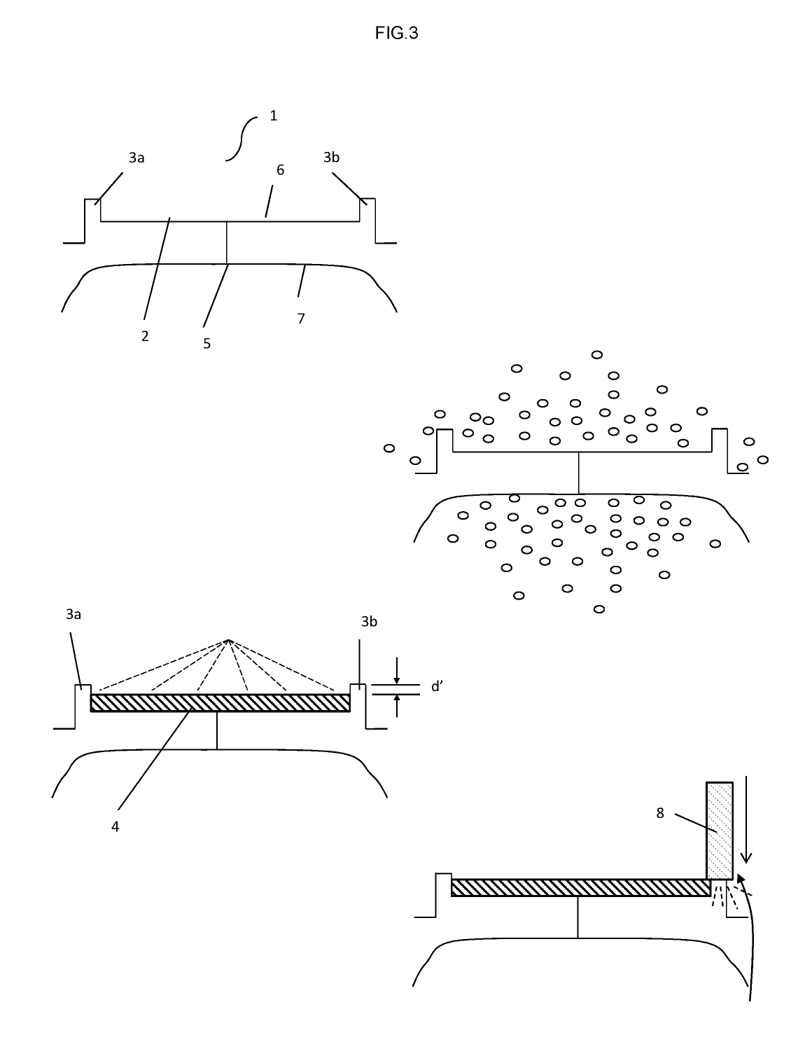

FIGS. 1 and 2 have been described above. Novel aspects of the method of the invention can be understood by referencing FIG. 3 with FIG. 2.

### DETAILED DESCRIPTION OF DRAWINGS AND SOME EMBODIMENTS

In step a) of FIG. 3 the drum 1 is formed from two disc forgings welded at weld 5 (though the drum need be welded from two components). The welded drum has a circumferentially outer surface 6 and circumferentially inner surface 7. Ribs 3a and 3b which may be machined from the welded forgings define the trough 2. In step b) the drum is shot peened on all surfaces to generate compressive stresses in the outer surface to discourage the propagation of cracks from within the forging or weld. In step c) an erosion resistant coating is applied in the trough, for example using a plasma spraying technique. The coating is applied to a depth which is a depth d′ less than the radially outermost surfaces of the ribs 3a, 3b. In step d), with the coating in place, the protruding depth d′ of the ribs 3a, 3b is removed in a turning operation by a lathe tool 8.

It will be appreciated that in the method of the invention, the coating is not succumbed to a shot peening operation. This permits the use of coatings which might be damaged by a shot peening operation. For example, the method allows for a range of top coats to be provided, for example to provide thermal barrier or chemical corrosion protection to the erosion resistant coating. Such coatings (which are often ceramic and brittle) can be easily damaged by shot peening. More generally, the method may reduce the number of machining operations needed to finish the component. Since turning is commonly used to machine features such as spigots around the circumference, the levelling of the ribs with the coating can be achieved as a continuation of the turning operation removing the need for a separate grinding operation. Consumable costs for the manufacture can thereby be reduced. Improved dimensional control is also achievable with a turning versus a grinding operation when the turning operation is performed in a single step with the machining of engine datums such as the spigot of the component.

Whilst the embodiment describes a drum for a compressor, the method also has application in the manufacture of other turbine engine components, for example in gear boxes and pumps.

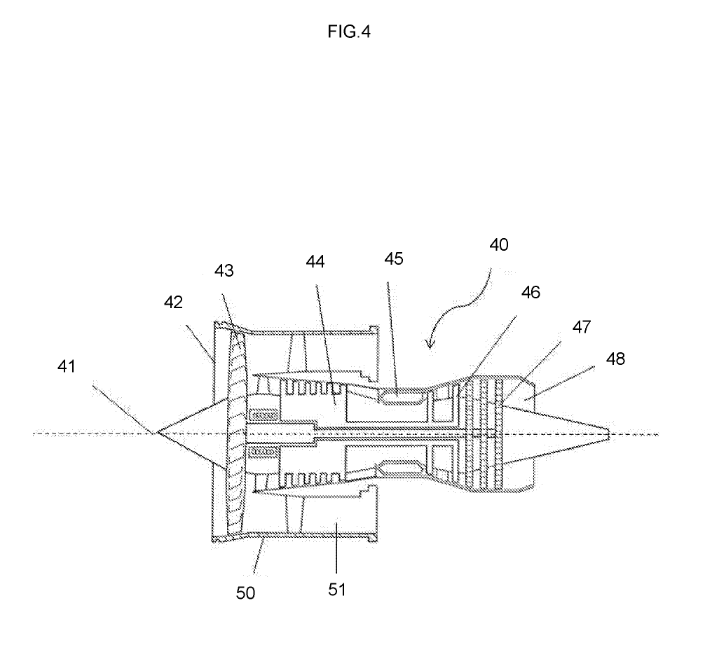

FIG. 4 shows a gas turbine engine into which components made in accordance with the invention might be incorporated.

With reference to FIG. 4, a gas turbine engine is generally indicated at 40, having a principal and rotational axis 41. The engine 40 comprises, in axial flow series, an air intake 42, a propulsive fan 43, a high-pressure compressor 44, combustion equipment 45, a high-pressure turbine 46, a low-pressure turbine 47 and an exhaust nozzle 48. A nacelle 50 generally surrounds the engine 40 and defines the intake 42.

The gas turbine engine 40 works in the conventional manner so that air entering the intake 42 is accelerated by the fan 43 to produce two air flows: a first air flow into the high-pressure compressor 44 and a second air flow which passes through a bypass duct 51 to provide propulsive thrust. The high-pressure compressor 44 compresses the air flow directed into it before delivering that air to the combustion equipment 45.

In the combustion equipment 45 the air flow is mixed with fuel and the mixture combusted. The resultant hot combustion products then expand through, and thereby drive the high and low-pressure turbines 46, 47 before being exhausted through the nozzle 48 to provide additional propulsive thrust. The high 46 and low 47 pressure turbines drive respectively the high pressure compressor 44 and the fan 43, each by suitable interconnecting shaft.

For example, the drum of compressor 44 may be manufactured in accordance with the method of the invention.

Other gas turbine engines to which the present disclosure may be applied may have alternative configurations. By way of example such engines may have an alternative number of interconnecting shafts (e.g. three) and/or an alternative number of compressors and/or turbines. Further the engine may comprise a gearbox provided in the drive train from a turbine to a compressor and/or fan.

It will be understood that the invention is not limited to the embodiments above-described and various modifications and improvements can be made without departing from the scope of the invention as described in the appended claims. Except where mutually exclusive, any of the features may be employed separately or in combination with any other features and the disclosure extends to and includes all combinations and sub-combinations of one or more features described herein.

1. A method for the manufacture of a cylindrical component suited to use in a high temperature environment and incorporating an erosion resistant coating on its outer cylindrical surface, the method comprising, in sequential steps;
providing a work piece having a cylindrical body including a pair of axially spaced radially extending ribs defining an annular trough therebetween,
shot peening the work piece,
applying an erosion resistant coating in the annular trough to a depth which sits radially inwardly of the radially outermost ends of the ribs,
turning the radially outermost ends of the ribs whereby to match the depth of the coating and provide an outer cylindrical surface with a consistent diameter across both ribs and the coating.

2. A method as claimed in claim 1 wherein, the cylindrical component is configured to serve as a drum of a compressor of a gas turbine engine.

3. A method as claimed in claim 1 wherein the work piece comprises a drum made from a plurality of disc forgings welded together.

4. A method as claimed in claim 3 wherein the trough extends across one or more welded joints.

5. A method as claimed in claim 1 wherein the erosion resistant coating is applied using a thermal spraying process.

6. A method as claimed in claim 1 wherein the work piece comprises a high temperature alloy which is a nickel based alloy or a titanium based alloy.

7. A method as claimed in claim 1 wherein the coating is a multi-layered coating.

8. A method as claimed in claim 7 wherein the coating comprises a first layer of an erosion resistant coating and a top layer of a thermally insulating material.

9. A method as claimed in claim 1 wherein the erosion resistant coating is a self-bonding coating.

10. A method as claimed in claim 1 wherein the erosion resistant coating comprises particles of a mechanically clad, chemically clad or gas atomised combination of Nickel and Aluminium.

11. A method as claimed in claim 10 wherein the Nickel component of the erosion resistant coating comprises 80% or greater.

12. A method as claimed in claim 11 wherein the Nickel component comprises from 90% to 96%.

13. A method as claimed in claim 8 wherein the top layer comprises a ceramic material.

14. A method as claimed in claim 13 wherein the ceramic comprises an Yttria stabilised Zirconia (YSZ).

15. A method as claimed in claim 14 wherein the YSZ comprises 90% or greater of Zircona.

16. A method as claimed in claim 15 wherein the YSZ comprises 91-93% Zirconia and up to 9% Yttria.

17. A method as claimed in claim 8 wherein the top layer is provided from a powder and deposited using a thermal spraying process.

18. A method as claimed in claim 17 wherein the erosion resistant coating comprises particles of a mechanically clad, chemically clad or gas atomised combination of Nickel and Aluminium.

19. A method as claimed in claim 9 wherein the coating comprises a first layer of an erosion resistant coating and a top layer of a thermally insulating material which is provided from a powder and deposited using a thermal spraying process.

20. A method for manufacturing a gas turbine engine including the steps of providing one or more components which are susceptible to erosion by means of the method of claim 1 and assembling these with other components into the gas turbine engine.
